(19) United States
(12) Patent Application Publication
(10) Pub. No.: US 2007/0210673 A1
(43) Pub. Date: Sep. 13, 2007

(54) Fuel pump having bearing member

(75) Inventor: Katsuhiko Kusagaya, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/712,415

(22) Filed: Mar. 1, 2007

(30) Foreign Application Priority Data
Mar. 7, 2006 (JP) 2006-060955
Dec. 11, 2006 (JP) 2006-333082

(51) Int. Cl. H01R 39/38

(52) U.S. Cl. 310/239

(57) ABSTRACT

A fuel pump includes a pump device for pumping fuel. The fuel pump further includes a motor device that has a commutator and an armature including a shaft. The commutator commutating electricity supplied to the armature for rotating the armature to drive the pump device. The fuel pump further includes a brush supplying electricity to the armature by making contact with the commutator. The fuel pump further includes a bearing member supporting the shaft. The fuel pump further includes a holder including a partition wall for supporting the bearing member. The partition wall electrically insulates the bearing member from the brush. The bearing member has a first bearing end surface on a side of the commutator. The partition wall has a wall end surface on a side of the commutator. The first bearing end surface is on an opposite side of the commutator with respect to the wall end surface.

### CROSS REFERENCE TO RELATED APPLICATIONS

This application is based on and incorporates herein by reference Japanese Patent Applications No. 2006-60955 filed on Mar. 7, 2006 and No. 2006-333082 filed on Dec. 11, 2006.

### FIELD OF THE INVENTION

The present invention relates to a fuel pump having a bearing member.

### BACKGROUND OF THE INVENTION

According to JP-A-63-272994, a fuel pump includes a motor device and a pump device. The motor device includes a brush. The pump device pumps fuel to flow the fuel through the motor device. As shown in FIG. 8, a conventional fuel pump includes an armature 42, a commutator 70, a bearing member 18, brushes 27, and a holder portion 201. The armature 42 and the commutator 70 construct a motor device 4. The bearing member 18 supports a shaft 19 of the armature 42. The brushes 27 supply electricity to the armature 42 by making contact with a commutating surface of the commutator 70. The holder portion 201 supports the bearing member 18.

The bearing member 18 and the brushes 27 are arranged relative to each other. The holder portion 201 includes a partition wall 203 that insulates the bearing member 18 electrically from the brushes 27. The bearing member 18 is press-inserted into the partition wall 203 of the holder portion 201 in the direction away from the commutator 70. The bearing member 18 has the end surface 181 opposed to the commutator 70. The partition wall 203 has the end surface 204 opposed to the commutator 70. The end surface 181 of the bearing member 18 and the end surface 204 of the partition wall 203 are located on the same plane.

The partition wall 203 of the holder portion 201 restricts the shaft 19 of the armature 42 from causing shortcircuit electrically with the brushes 27 via the holder portion 201 and the bearing member 18. However, a metallic constituent contained in fuel may adhere to the end surface 204 of the partition wall 203 of the holder portion 201. In particular, when fuel contains alcohol, the alcohol elutes a metallic constituent into the fuel. Consequently, a metallic constituent may further possibly adhere to the surface 204 of partition wall 203 of the holder portion 201.

When such a metallic constituent adheres to the partition wall 203 of the holder portion 201, the bearing member 18 may cause shortcircuit with the brushes 27 via the metallic constituent. As a result, the shaft 19 of the armature 42 causes shortcircuit electrically with the brushes 27 via the adhering metallic constituent and the bearing member 18. Consequently, the motor device 4 causes malfunction.

### SUMMARY OF THE INVENTION

The present invention addresses the above disadvantage. According to one aspect of the present invention, a fuel pump includes a pump device for pumping fuel. The fuel pump further includes a motor device that includes a commutator and an armature. The armature includes a shaft being a rotation center. The commutator commutates electricity supplied to the armature for rotating the armature to drive the pump device. The fuel pump further includes a brush for supplying electricity to the armature by making contact with the commutator. The fuel pump further includes a bearing member for rotatably supporting the shaft. The fuel pump further includes a holder that includes a partition wall for supporting the bearing member. The partition wall electrically insulates the bearing member from the brush. The bearing member has a first bearing end surface on a side of the commutator. The partition wall has a wall end surface on a side of the commutator. The first bearing end surface is on an opposite side of the commutator with respect to the wall end surface.

According to another aspect of the present invention, a fuel pump includes a pump device for pumping fuel. The fuel pump further includes a motor device that includes an armature including a shaft. The motor device further includes a commutator for commutating electricity supplied to the armature for rotating the pump device via the shaft. The fuel pump further includes a brush for supplying the electricity to the armature by making contact with the commutator. The fuel pump further includes a bearing member for radially supporting the shaft. The fuel pump further includes a holder that includes a partition wall for supporting the bearing member. The partition wall is interposed between the brush and the bearing member with respect to a radial direction of the shaft for electrically insulating the bearing member from the brush. The bearing member has a first bearing end surface opposed to the commutator with respect to an axial direction of the shaft. The partition wall has a wall end surface opposed to the commutator with respect to the axial direction of the shaft. The wall end surface is interposed between the first bearing end surface and the commutator with respect to the axial direction of the shaft.

### BRIEF DESCRIPTION OF THE DRAWINGS

The above and other objects, features and advantages of the present invention will become more apparent from the following detailed description made with reference to the accompanying drawings. In the drawings:

FIG. 1 is a sectional view showing a fuel pump according to a first embodiment;

FIG. 2 is a view showing a pump cover of the fuel pump being viewed from the arrow 11 in FIG. 1;

FIG. 3 is a sectional view taken along the line III-O-III in FIG. 2;

FIG. 4 is a sectional view showing a shaft and a bearing member of a fuel pump according to a second embodiment;

FIG. 5 is a sectional view showing a fuel pump according to a third embodiment;

FIG. 6 is a sectional view showing a shaft and a bearing member of the fuel pump in FIG. 5;

FIG. 7 is a graph showing an experimental result indicating a relationship between abrasion caused in a thrust support of the fuel pump and a travel distance of a vehicle; and

FIG. 8 is a sectional view showing a shaft and a bearing member of a fuel pump according to a prior art.

### DETAILED DESCRIPTION OF PREFERRED EMBODIMENTS

### First Embodiment

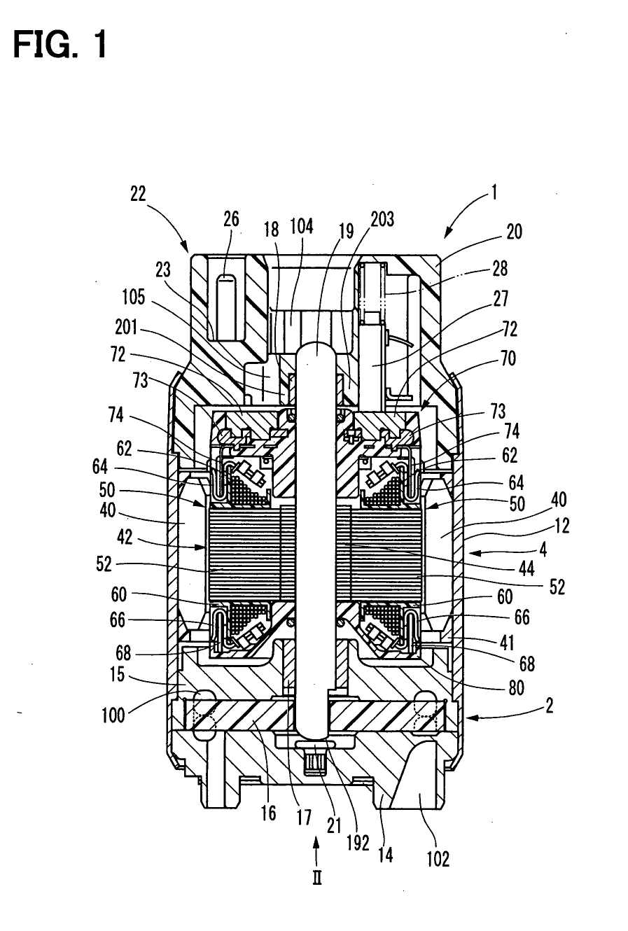

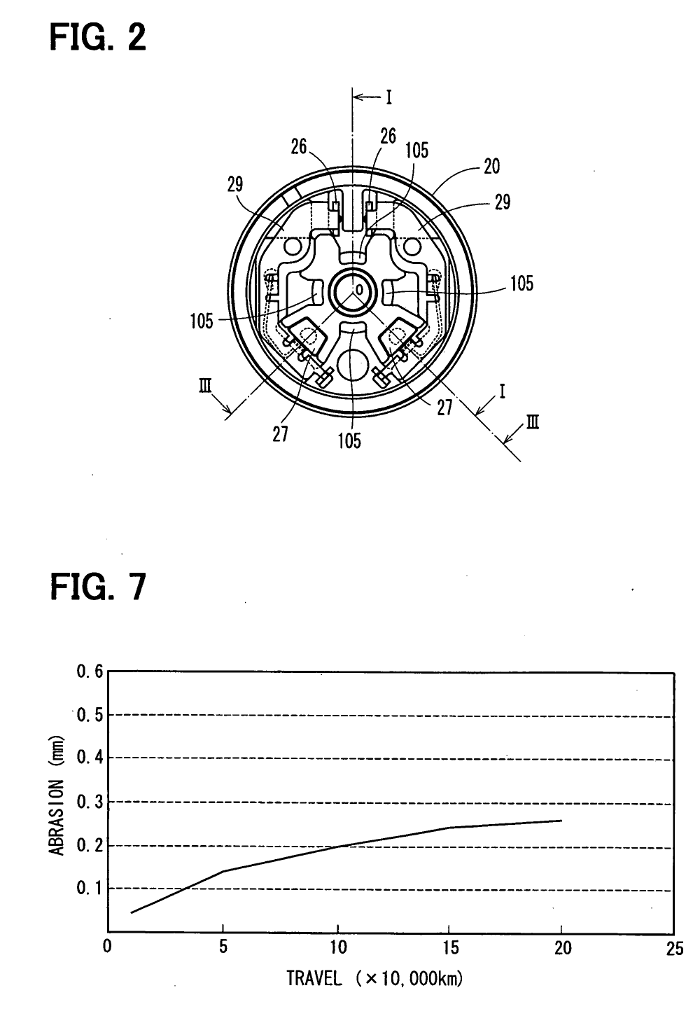

FIG. 1 is a sectional view taken along the line I-O-I in FIG. 2. The fuel pump 1 is an in-tank type pump that is provided in a fuel tank of a vehicle, for example. The fuel pump 1 includes a pump device 2 and a motor device 4. The pump device 2 pressurizes fuel. The motor device 4 includes an armature 42 that rotates to drive the pump device 2. The pump device 2 includes an inlet cover 14, an impeller casing 15, and an impeller 16. The motor device 4 is a DC motor constructed of permanent magnets 40, the armature 42, and a commutator 70.

The armature 42 includes a shaft 19 serving as a rotative member. The shaft 19 has both ends to which the inlet cover 14 and an outlet cover 20 are respectively provided. The outlet cover 20 serves as a pump cover. The fuel pump 1 includes a housing 12 that is crimped to fix the inlet cover 14 with the outlet cover 20.

The impeller casing 15 is interposed between the inlet cover 14 and the housing 12. The inlet cover 14 and the impeller casing 15 define C-shaped pump passages 100 therebetween. The inlet cover 14 and the impeller casing 15 serve as case members that rotatably accommodate the impeller 16 serving as a rotative member. The impeller casing 15 has the inner circumferential periphery that supports a bearing member 17.

The impeller 16 in a substantially disc-shape has the outer circumferential periphery, to which multiple vane grooves are provided. The armature 42 rotates, so that the impeller 16 rotates together with the shaft 19. Thereby, hydraulic frictional force generates differential pressure between the foreside of the grooves and the backside of the grooves. Fuel in the pump passages 100 is pressurized by repeating the generation of the differential pressure using vane grooves. The inlet cover 14 has a fuel inlet port 102. As the impeller 16 rotates, fuel is drawn from the fuel tank into the pump passages 100 through the fuel inlet port 102. The drawn fuel is discharged from the impeller casing 15 toward the cover 80, which is provided to the end of the armature 42 on the opposite side of the commutator 70.

The fuel further flows toward the commutator 70 after passing around the outer circumferential periphery of the armature 42. The fuel further flows from four communication passages 105 to a fuel outlet 104, so that the fuel is supplied from the fuel pump 1 to the engine. The four communication passages 105 are formed in the outlet cover 20 such that the four communication passages 105 surround the shaft 19. In the sectional view depicted in FIG. 1, the pump passages 100 do not communicate with the fuel inlet port 102.

The outlet cover 20 is formed of resin. The outlet cover 20 surrounds the motor device 4 on the side of the commutator 70. The fuel outlet 104 is defined around the axis of the shaft 19 in a substantially center of the outlet cover 20. An incoming connector 22 is provided around the outer circumferential periphery of the outlet cover 20. The incoming connector 22 is arranged eccentrically relative to the outlet cover 20. The incoming connector 22 includes a recess 23, to which terminals 26 are provided. The terminals 26 are press-fitted to the outlet cover 20. The armature 42 is supplied with electricity via the terminals 26.

As shown in FIG. 2, pump components, which include brushes 27, springs 28, plates 29, and the like, are provided to the outlet cover 20 on the side of the commutator 70, i.e. on the backside of the outlet cover 20. The springs 28 respectively bias the brushes 27 toward the commutator 70. The plates 29 electrically connect the terminals 26 respectively with the brushes 27. Each of the terminals 26 and each of the brushes 27 overlap one another with respect to the axial direction of the fuel pump 1.

As referred to FIG. 1, each of the permanent magnets 40 is in a substantially quadrant arch shape. Four permanent magnets 40 are circumferentially arranged along the inner circumferential periphery of the housing 12. The permanent magnets 40 define four magnetic poles, which are different from each other with respect to the rotative direction of the impeller 16. The permanent magnets 40 are supported using a resin member 41. The commutator 70 is provided to the armature 42 on the opposite side of the impeller 16. The shaft 19 of the armature 42 serves as the rotative member. The shaft 19 is rotatably supported using bearing members 17, 18. The bearing members 17, 18 are supported respectively to the impeller casing 15 and the outlet cover 20.

The armature 42 includes a center core 44 in the rotation center thereof. The shaft 19 is press-inserted into the center core 44. Six magnetic pole coils 50 are provided to the outer circumferential periphery of the center core 44, and are arranged with respect to the rotative direction. The six magnetic pole coils 50 connect to the center core 44. Each of the six magnetic pole coils 50 includes a coil core 52, a bobbin 60, and a coil 62. The coil 62 is a concentrated winding formed by winding a wire around the bobbin 60. The six magnetic pole coils 50 are the same substantially in structure.

Each of the coils 62 has the end, which is on the side of the commutator 70, electrically connecting with each of the terminals 64. Each of the terminals 64 engages with a terminal 74 of the commutator 70, so that the terminal 64 electrically connects with the terminal 74. Each of the coils 62 has the end on the opposite side of the commutator 70. This end of the coil 62 on the side of the impeller 16 electrically connects with each of the terminals 66. Three terminals 66, which are adjacent to each other with respect to the rotative direction, electrically connect with each other via terminals 68.

The commutator 70 is integrally formed, and has a cassette-type structure. The commutator 70 includes six segments 72 that are arranged with respect to the rotative direction. The six segments 72 are formed of carbon, for example. The segments 72, which are adjacent to each other with respect to the rotative direction, are electrically insulated from each other. Each of the segments 72 electrically connects with each of the terminals 74 via an intermediate terminal 73. Each of the segments 72 sequentially makes contact with each of the brushes 27, as the armature 42 rotates.

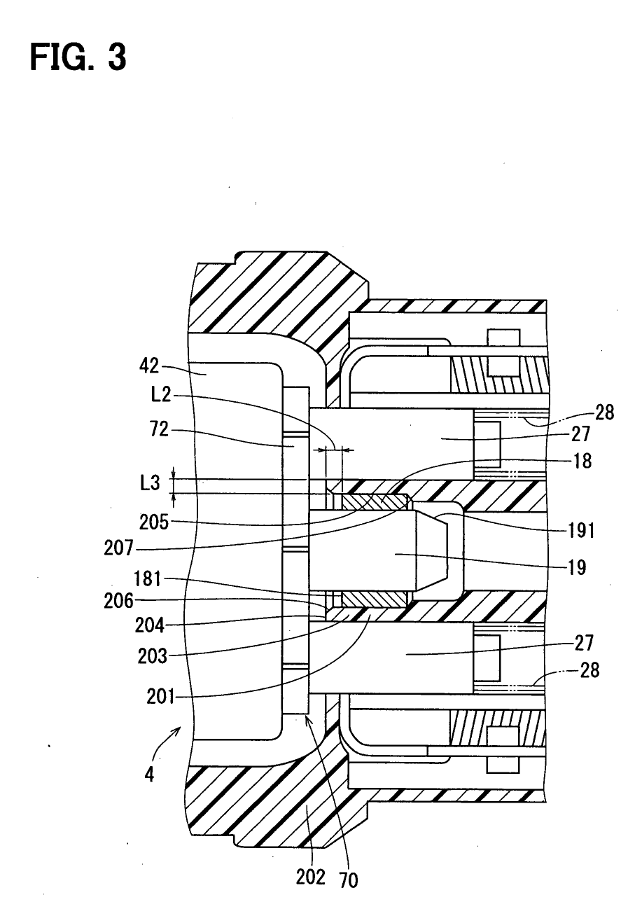

Next, the structure of the bearing member 18 is described with reference to FIG. 3. The bearing member 18 is a sliding bearing, which does not include a roller member such as a ball. Specifically, the bearing member 18 is a solid sleeve in a cylindrical shape, for example. The bearing member 18 defines a cylindrical member into which the shaft 19 is inserted. The shaft 19 is radially supported by the radially inner surface of the cylindrical member defining the bearing member 18 such that the shaft 19 is rotatable with respect to the bearing member 18. The bearing member 18 is formed of a metallic material, which is, in particular, a cuprous sintered material, resistive to abrasion.

The outlet cover 20 (FIG. 1) is formed of resin. The outlet cover 20 includes a holder portion 201 and a cover portion 202 (FIG. 3). The holder portion 201 accommodates the bearing member 18 to support the bearing member 18 therein. The cover portion 202 surrounds the motor device 4 on the side of the commutator 70. The holder portion 201 serves as a holder. The cover portion 202 serves as a cover.

The holder portion 201 has an accommodation hole 205, which is substantially coaxial with respect to the shaft 19. The bearing member 18 is press-inserted into the accommodation hole 205. Thus, the bearing member 18 is supported by the holder portion 201. The holder portion 201 has a partition wall 203 that is interposed between the bearing member 18 and the brush 27. The partition wall 203 electrically insulates the bearing member 18 from the brush 27. The partition wall 203 has a step 207, in which the partition wall 203 further reduces in inner diameter with respect to the accommodation hole 205. That is, the inner diameter of the partition wall 203 stepwisely decreases at the step 207 relative to the accommodation hole 205. The bearing member 18 is press-inserted into the partition wall 203 such that the bearing member 18 makes contact with the step 207. The step 207 is in a substantially annular shape.

The shaft 19 has a tip end on the right side in FIG. 3. The tip end of the shaft 19 extends from the portion via which the shaft 19 is supported by the bearing member 18, so that the tip end of the shaft 19 is out of the bearing member 18. The tip end of the shaft 19 has a chamfer portion 191 having a chamfer. The partition wall 203 has a tip end on the side of the segment 72. This tip end of the partition wall 203 has a chamfer portion 206. The chamfer portions 191, 206 are provided, so that insertion of the shaft 19 into the bearing member 18 can be facilitated. The chamfer portions 191, 206 are respectively in substantially annular shapes.

The spring 28 biases the brush 27 onto the segment 72. In this structure, the tip end of the brush 27 protrudes axially beyond the end surface 204 of the partition wall 203 toward the segment 72. The end surface 204 of the partition wall 203 is opposed to the segment 72. The bearing member 18 has an end surface 181, which is opposed to the segment 72. The end surface 181 of the bearing member 18 is on the opposite side of the segment 72 with respect to the end surface 204 of the partition wall 203. That is, the end surface 181 of the bearing member 18 and the segment 72 axially interpose the end surface 204 of the partition wall 203 therebetween.

As referred to FIG. 1, fuel discharged from the pump device 2 flows through the space between the cover portion of the outlet cover 20 and the commutator 70. In this structure, the end surface 204, via which the partition wall 203 is opposed to the segment 72, is submerged in fuel. Accordingly, a metallic constituent contained in fuel may be eluted to adhere to the end surface 204 of the partition wall 203.

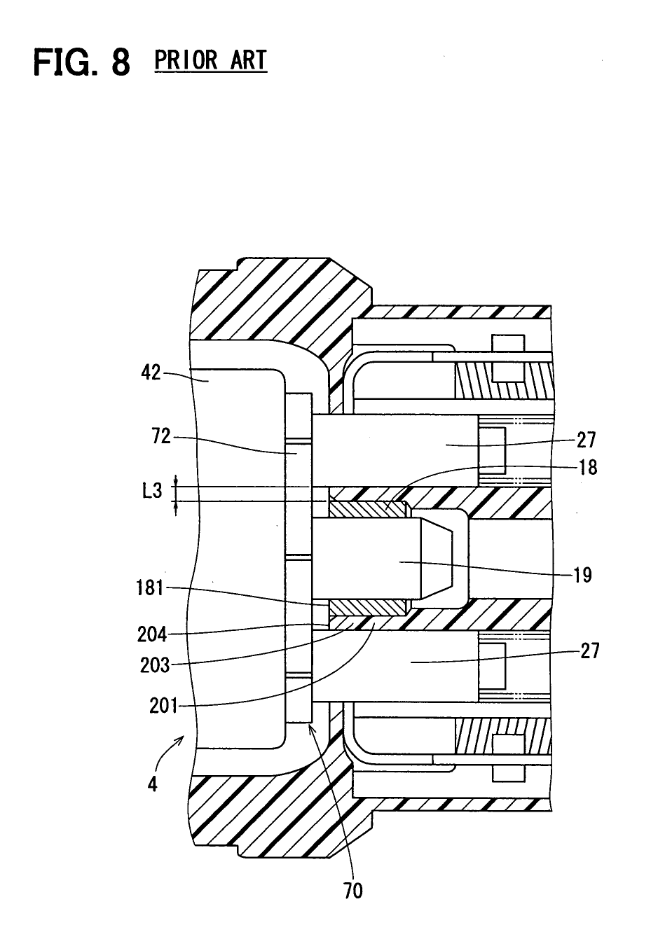

In this embodiment, the end surface 181 of the bearing member 18 is on the opposite side of the segment 72 with respect to the end surface 204 of the partition wall 203. Therefore, the length of the shortcircuit path between the end surface 181 of the bearing member 18 and the brush 27 is greater than the length of the shortcircuit path in the structure shown in FIG. 8. In FIG. 8, the end surface 181 of the bearing member 18 is on the same surface as the end surface 204 of the partition wall 203. Specifically, the length of the shortcircuit path in the structure of FIG. 8 is equivalent to the radial length shown by L3 in FIG. 8. By contrast, the length of the shortcircuit path in this embodiment shown in FIG. 3 is equivalent to the sum of the radial length L3 and the axial distance L2.

Therefore, in this embodiment, even when a metallic constituent contained in fuel adheres to the end surface 204 of the partition wall 203, the bearing member 18 and the brush 27 can be restricted from causing shortcircuit due to the metallic constituent adhering to the end surface 204 of the partition wall 203. Therefore, the shaft 19 of the armature 42 and the brush 27 can be restricted from causing shortcircuit therebetween via an adhering metallic constituent and the bearing member 18. Thus, the motor device 4 can be restricted from causing malfunction.

### Second Embodiment

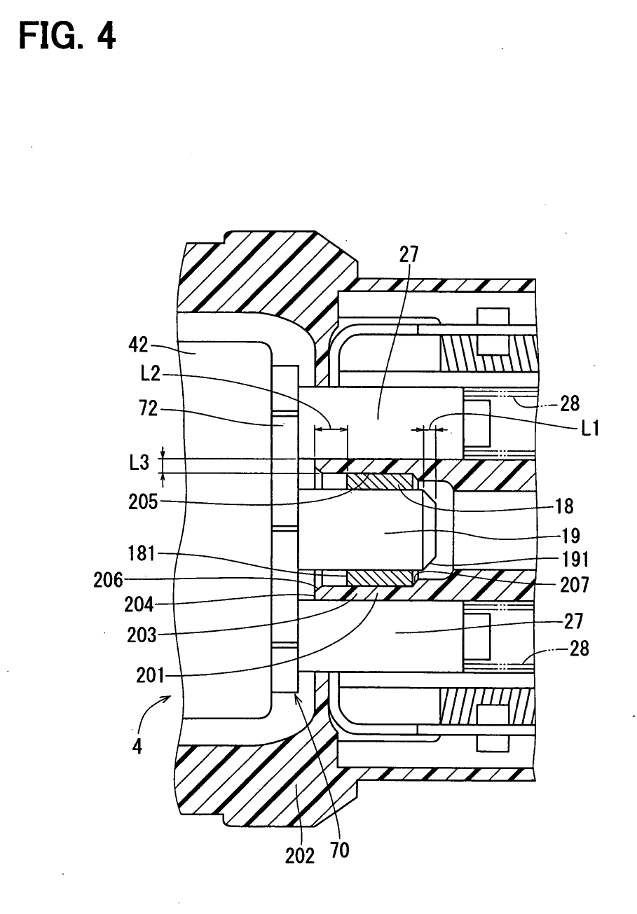

As shown in FIG. 4, the shaft 19 has a tip end on the opposite side of the segment 72. This tip end of the shaft 19 extends from the portion via which the shaft 19 is supported by the bearing member 18, so that the tip end of the shaft 19 is out of bearing member 18. The tip end of the shaft 19 has a chamfer portion 191. The chamfer portion 191 of the shaft 19 has the axial length L1 with respect to the axial direction of the shaft 19. In this second embodiment, the axial length L1 of the chamfer portion 191 is less than the axial length of the chamfer portion 191 in the first embodiment. Specifically, the end surface 204, via which the partition wall 203 is opposed to the segment 72, is away from the end surface 181, via which the bearing member 18 is opposed to the segment 72, at the axial distance L2 with respect to the axial direction. The axial length L1 of the chamfer portion 191 is set to be less than the axial distance L2.

Here, as the axial distance L2 is set greater by arranging the bearing member 18 away from the commutator 70, the shaft 19 and the brush 27 can be further restricted from causing shortcircuit therebetween. However, by contrast, the shaft 19 needs to be elongated for securing the contact area defining the sliding portion between the shaft 19 and the bearing member 18, consequently, the fuel pump may be jumboized in the axial direction.

In this structure of the second embodiment, the axial length L1 of the chamfer portion 191 is set small, so that the bearing member 18 is arranged to be distant from the segment 72, and the axial distance L2 can be set large. Thus, the bearing member 18 and the brush 27 can be restricted from causing shortcircuit therebetween via an adhering metallic constituent contained in fuel. Furthermore, the sliding portion, via which the shaft 19 makes contact with the bearing member 18, can be secured without axially extending of the shaft 19. Therefore, the bearing member 18 and the brush 27 can be further restricted from causing shortcircuit therebetween, while the fuel pump is restricted from axially jumboized.

### Third Embodiment

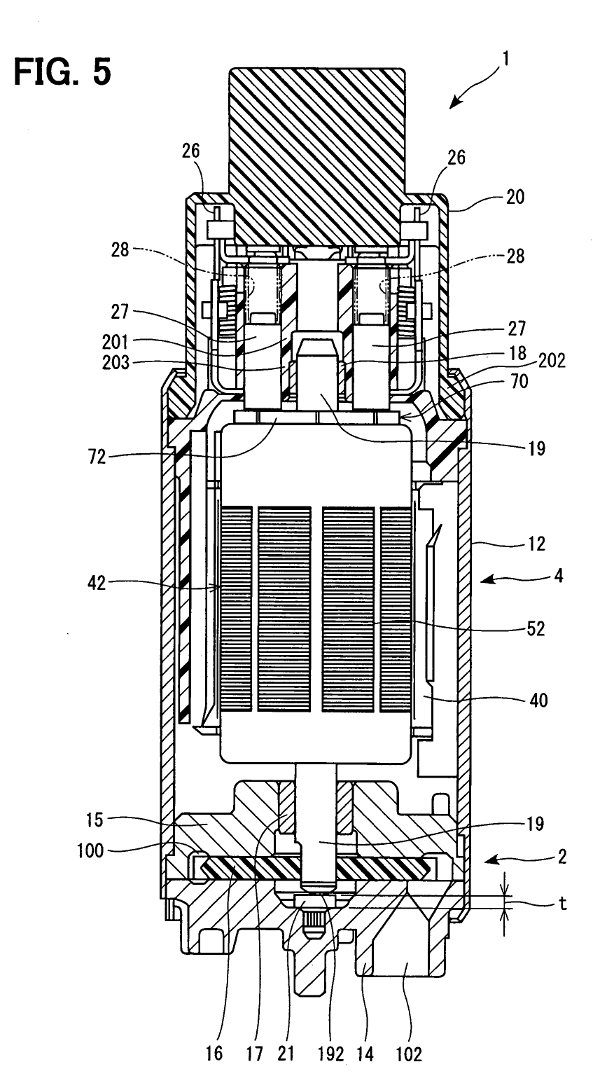

In the above first embodiment, the holder portion 201 including the partition wall 203 is formed of resin integrally with the cover portion 202, which surround the motor device 4 from the commutator 70. By contrast, in the third embodiment, as shown in FIG. 5, the holder portion 201 including the partition wall 203 is provided separately from the cover portion 202. The inlet cover 14 is provided with a thrust support member 21. The thrust support member 21 receives the end surface 192 of the shaft 19 of the armature 42 with respect to the thrust direction. The end surface 192 of the shaft 19 is located of the side of the bearing member 17. The thrust support member 21 is formed of a steel material such as carbon steel. The thrust support member 21 is applied with heat treatment such as GNC treatment by carbo-nitriding, quenching, and tempering.

The thrust support member 21 has a support portion, which makes contact with the end surface 192 of the shaft 19. When the support portion of the thrust support member 21 abrades, the shaft 19 becomes apt to entirely move toward the thrust support member 21. In this condition, the tip end of the shaft 19 having the chamfer portion 191 may move into the bearing member 18.

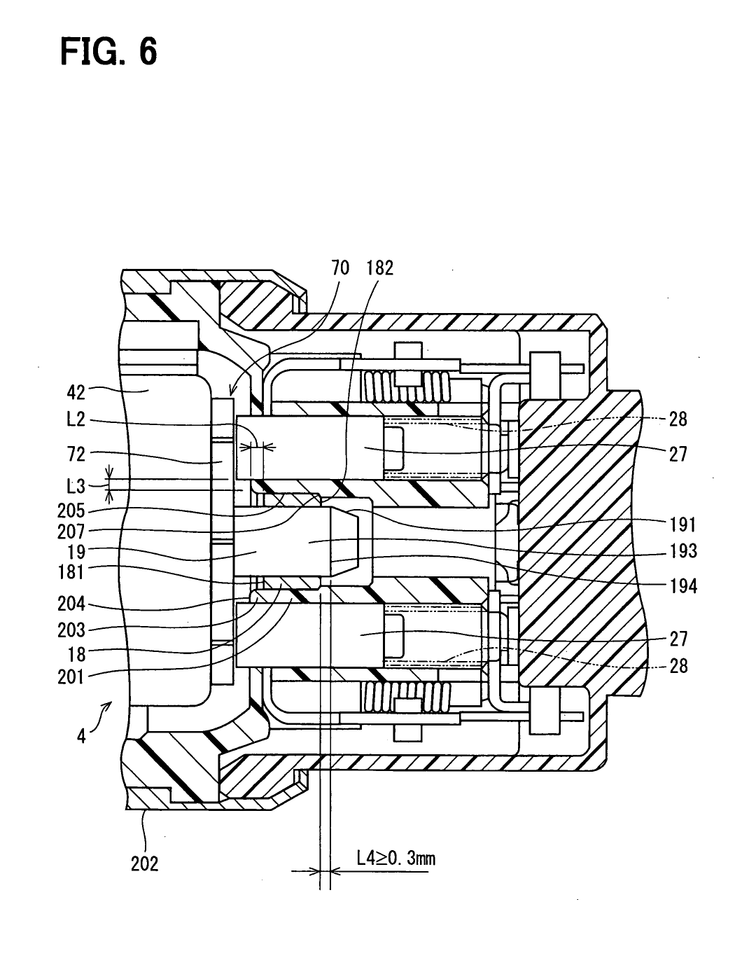

In this third embodiment, as shown in FIG. 6, the shaft 19 has a non-chamfer portion (bar-shaped portion) 193, in which the chamfer portion 191 is not provided. The shaft 19 has a boundary 194 between the non-chamfer portion 193 and the chamfer portion 191. The bearing member 18 has an end surface 182 on the opposite side of the commutator 70. The boundary 194 is located on the opposite side of the commutator 70 with respect to the end surface 182 of the bearing member 18. That is, the boundary 194 is located on the right side in FIG. 6 with respect to the commutator 70 and the end surface 182 of the bearing member 18.

Therefore, even when the thrust support member 21 is worn and the shaft 19 moves toward the thrust support member 21, the chamfer portion 191 can be restricted from moving into the bearing member 18. Thus, the sliding surface, via which the bearing member 18 supports the shaft 19, can be maintained.

Next, an experimental result of abrasion caused in the thrust support member 21 is described. As an initial condition, the thickness t of the thrust support member 21, when the thrust support member 21 does not abrade in the condition shown in FIG. 5, is set at 1 mm. According to the experimental result shown in FIG. 7, as the travel of the vehicle increases, the abrasion caused in the thrust support member 21 increases. The increase in the abrasion gradually decreases, as the travel of the vehicle increases, so that the abrasion converges to a value equal to or less than 0.3 mm. In accordance with the experimental result in FIG. 7, in this embodiment, the distance L4 between the end surface 182 of the bearing member 18 and the boundary 194 is set to be equal to or greater than 0.3 mm, as shown in FIG. 6. In this structure, the chamfer portion 191 can be steadily restricted from moving into the bearing member 18.

### Other Embodiment

In the above first and second embodiments, the holder portion 201 including the partition wall 203 is formed of resin integrally with the cover portion 202 that covers the motor device 4 from the commutator 70. Alternatively, the holder portion 201 may be provided separately from the cover portion 202.

In the above first and second embodiments, the bearing member 18 is supported by the holder portion 201 by being press-inserted into the accommodation hole 205 of the holder portion 201. Alternatively, the bearing member 18 may be insert-molded integrally with the holder portion 201.

In the above second embodiment, the axial length L1 of the chamfer portion 191 is set to be less than the axial distance L2. Alternatively, the axial length L1 of the chamfer portion 191 may be set to be less than the thickness L3 of the partition wall 203. The chamfer portion 191 may be in the tapered shape shown in FIG. 4. Alternatively, the chamfer portion 191 may be in an outwardly protruding arc shape (R-shape), as shown in FIG. 1.

In the above third embodiment, the distance L4 between the end surface 182 of the bearing member 18 and the boundary 194 is set to be equal to or greater than 0.3 mm. Alternatively, the distance L4 may be set equal to or greater than the value calculated by multiplying the thickness t of the thrust support member 21 by 0.3 mm. That is, the distance L4 may be set to satisfy: L4≧0.3×t. Even in this definition of the distance L4, the chamfer portion 191 can be steadily restricted from moving into the bearing member 18.

The distance L4 may be set equal to or greater than 0.5 mm, instead of being equal to or greater than 0.3 mm. In this structure, the chamfer portion 191 can be further steadily restricted from moving into the bearing member 18.

The above structures of the embodiments can be combined as appropriate.

Various modifications and alternations may be diversely made to the above embodiments without departing from the spirit of the present invention.

What is claimed is:

1. A fuel pump comprising:
a pump device for pumping fuel;
a motor device that includes a commutator and an armature, the armature including a shaft being a rotation center, the commutator commutating electricity supplied to the armature for rotating the armature to drive the pump device;
a brush for supplying electricity to the armature by making contact with the commutator;
a bearing member for rotatably supporting the shaft; and
a holder that includes a partition wall for supporting the bearing member, the partition wall electrically insulating the bearing member from the brush,
wherein the bearing member has a first bearing end surface on a side of the commutator,
the partition wall has a wall end surface on a side of the commutator, and
the first bearing end surface is on an opposite side of the commutator with respect to the wall end surface.

2. The fuel pump according to claim 1, further comprising:
a cover that is located on a side of the commutator to surround the brush and the motor device,
wherein the holder is integrated with the cover.

3. The fuel pump according to claim 1,
wherein the shaft has an end via which the bearing member supports the shaft,
the end of the shaft has a chamfer portion that has an axial length L1 with respect to an axial direction of the shaft,
the wall end surface is opposed to the commutator,
the first bearing end surface is opposed to the commutator,
the wall end surface is away from the first bearing end surface at a distance L2,
the partition wall has a thickness L3, and
the axial length L1 of the chamfer portion is less than at least one of the distance L2 and the thickness L3.

4. The fuel pump according to claim 1,
wherein the shaft has a shaft end surface on an opposite side of the commutator,
the fuel pump further comprising:
a thrust support member that supports the shaft end surface with respect to a thrust direction,
wherein the shaft has an end via which the bearing member supports the shaft,
the end of the shaft has a chamfer portion and a bar portion,
the chamfer portion connects with the bar portion to define a boundary therebetween,
the bearing member has a second bearing end surface on an opposite side of the commutator, and
the boundary is on an opposite side of the commutator with respect to the second bearing end surface.

5. The fuel pump according to claim 4, wherein the second bearing end surface is away from the boundary at a distance equal to or greater than 0.3 mm.

6. The fuel pump according to claim 4,
wherein the thrust support member has a thickness t with respect to a thrust direction,
the second bearing end surface is away from the boundary at a distance L4, and
the thickness t and the distance L4 satisfies L4≧0.3×t.

7. The fuel pump according to claim 1, wherein the bearing member is located on the side of the commutator.

8. The fuel pump according to claim 1,
wherein the partition wall has an inner surface, which is in a substantially cylindrical shape, for receiving the bearing member,
the shaft, the bearing member, the inner surface of the partition wall, are arranged substantially coaxially with respect to each other, and
the brush is arranged outside of the partition wall with respect to the radial direction of the shaft.

9. A fuel pump comprising:
a pump device for pumping fuel;
a motor device that includes an armature including a shaft, the motor device further including a commutator for commutating electricity supplied to the armature for rotating the pump device via the shaft;
a brush for supplying the electricity to the armature by making contact with the commutator;
a bearing member for radially supporting the shaft; and
a holder that includes a partition wall for supporting the bearing member,
wherein the partition wall is interposed between the brush and the bearing member with respect to a radial direction of the shaft for electrically insulating the bearing member from the brush,
the bearing member has a first bearing end surface opposed to the commutator with respect to an axial direction of the shaft,
the partition wall has a wall end surface opposed to the commutator with respect to the axial direction of the shaft, and
the wall end surface is interposed between the first bearing end surface and the commutator with respect to the axial direction of the shaft.

10. The fuel pump according to claim 9,
wherein the partition wall has an inner surface, which is in a substantially cylindrical shape, for receiving the bearing member,
the shaft, the bearing member, the inner surface of the partition wall, are arranged substantially coaxially with respect to each other, and
the brush is arranged outside of the partition wall with respect to the radial direction of the shaft.
